(19) United States
(12) Patent Application Publication
(10) Pub. No.: US 2015/0312997 A1
(43) Pub. Date: Oct. 29, 2015

(54) ION GENERATION DEVICE AND ELECTROSTATIC NEUTRALIZER USING SAME

(71) Applicant: SHARP KABUSHIKI KAISHA, Osaka-Shi, Osaka (JP)

(72) Inventor: Itaru MURUI, Osaka-shi (JP)

(21) Appl. No.: 14/647,830

(22) PCT Filed: Nov. 25, 2013
(86) PCT No.: PCT/JP2013/081619

§ 371 Date: May 28, 2015

(30) Foreign Application Priority Data
Feb. 12, 2013 (JP) 2013-024054

(51) Int. Cl. H05F 3/04; H01T 23/00

(52) U.S. Cl. CPC H05F 3/04; H01T 23/00

(57) ABSTRACT

First ion generation means and second ion generation means are arranged in substantially parallel to each other and arranged along a flow direction of conveying air in this order from an upstream side of the conveying air, polarities of ions radiated from ion generation electrodes, which are respectively opposing, of the first ion generation means and the second ion generation means are reverse polarities, an air duct wall is arranged so as to separate each pair of positive and negative electrodes to be paired over the first ion generation means and the second ion generation means, and a high-voltage power source applies a voltage to the first ion generation means and the second ion generation means alternately.

### TECHNICAL FIELD

The present invention relates to an ion generation device having a destaticizing function, which ionizes air to generate positive ions and negative ions by applying a high voltage to electrodes and, particularly, removes charges on a surface of a destaticization target by the ions.

### BACKGROUND ART

Conventionally, as one of electrostatic neutralizers which destaticize a destaticization target, an ion generation device which emits positive and negative ions has been used. In this ion generation device, a high voltage is applied to electrodes to thereby separate molecules in the air, and positive ions and negative ions are generated.

Such an ion generation device is able to be classified broadly into an AC pulse type and a DC pulse type. An ion generation device of the AC pulse type is generally a single electrode type which has one electrode, and when a voltage is applied to this electrode by a high-voltage power source, positive ions and negative ions are generated from the one electrode alternately and periodically. On the other hand, an ion generation device of the DC pulse type is generally a two-electrode type which has one set of two electrodes, and when a voltage is applied to each electrode by a high-voltage power source, positive ions are generated from an electrode for positive ions (positive electrode) and negative ions are generated from an electrode for negative ions (negative electrode).

Advantages of the single electrode type are that both of positive and negative ions are generated easily and uniformly without location dependency, a sum of ions around the electrode thereby becomes zero and ion balance becomes uniform easily, and, by changing a generation cycle of the both ions, a reachable distance of the ions is able to be controlled. On the other hand, disadvantages of the single electrode type are that control, a circuit configuration, etc. for generating equivalence of positive and negative ions from the single electrode become complicated compared with the two-electrode type.

On the other hand, in the two-electrode type, the DC pulse type is generally used, and the control, the circuit configuration, etc. for generating equivalence of positive and negative ions are simple compared with the single electrode type. However, in a normal configuration, there is also a disadvantage that positive ions exist excessively around the positive electrode and negative ions exist excessively around the negative electrode. That is, in this case, even if generation amounts of positive and negative ions are equal, there are a region of an excess of the positive ions and a region of an excess of the negative ions locally.

In view of such circumstances, for example, in an electrostatic neutralization device shown in PTL 1, positive electrodes and negative electrodes are alternately arranged, and further two opposing electrodes are arranged so as to have reverse polarities. With such a configuration, it is possible to maintain ion balance at every place regardless of a lapse of time.

FIG. 14 to FIG. 17 are schematic views of an electrostatic neutralization device 900 shown in the literature, in which FIG. 14 is a view viewed from a top surface, FIG. 15 is a view viewed from a front surface, FIG. 16 is a view viewed from a side surface, and FIG. 17 is a view viewed from a bottom surface. The electrostatic neutralization device 900 is configured by arranging two bar-like electrostatic neutralizer 901 and 902 in parallel, and polarities of ions radiated from adjacent discharge electrodes 901a and 902a are invariably reverse polarities. Since these two bar-like electrostatic neutralizers are closely arranged comparatively, ion balance becomes almost zero in a region 903 in which ions are radiated.

### CITATION LIST

### Patent Literature

PTL 1: Japanese Unexamined Patent Application Publication No. 2004-39419 (published on Feb. 5, 2004)

### SUMMARY OF INVENTION

### Technical Problem

However, in the electrostatic neutralization device 900 shown in PTL 1, in a case where electrodes having reverse polarities, which are laterally adjacent, generate ions simultaneously at all times, if flow of ions occurs in a width direction, neutralization of positive ions and negative ions is caused, so that a possibility of deactivation of ions becomes high. Moreover, in the case of arranging a positive electrode and a negative electrode simply with a spatial distance therebetween shortened, distribution of ion balance is improved, but positive ions and negative ions offset each other and an ion amount is thereby decreased in this case as well, so that there is a problem that an ion wind is not be able to reach in a wide range sufficiently.

In view of the aforementioned problems, the present invention aims to provide an ion generation device of which ion balance distribution is uniform and which is capable of making ions reach in a wide range with high ion concentration, and an electrostatic neutralizer.

### Solution to Problem

An ion generation device according to the present invention is an ion generation device, including: first ion generation means and second ion generation means in which positive ion generation electrodes and negative ion generation electrodes are arranged alternately in a row; a high-voltage power source that applies a high voltage to the first ion generation means and the second ion generation means; air blowing means for sending ions generated by the first ion generation means and the second ion generation means to an outside of electric equipment with conveying air; and an air duct wall that partitions the conveying air in an air flow direction, characterized in that the first ion generation means and the second ion generation means are arranged in substantially parallel to each other and arranged along the flow direction of the conveying air in this order from an upstream side of the conveying air, polarities of ions radiated from the ion generation electrodes, which are respectively opposing, of the first ion generation means and the second ion generation means are reverse polarities, the air duct wall is arranged so as to separate each pair of positive and negative electrodes to be paired over the first ion generation means and the second ion generation means, and the high-voltage power source applies the voltage to the first ion generation means and the second ion generation means alternately.

Moreover, it may be characterized in that an arrangement direction of the first ion generation means and the second ion generation means and the flow direction of the conveying air are substantially parallel, and the flow direction of the conveying air changes after passing through the first ion generation means and the second ion generation means.

Moreover, it may be characterized in that an arrangement interval of the ion generation electrodes of the first ion generation means is different from an arrangement interval of the ion generation electrodes of the second ion generation means.

Moreover, it may be characterized in that the arrangement interval of the ion generation electrodes of the first ion generation means is narrower than the arrangement interval of the ion generation electrodes of the second ion generation means.

An electrostatic neutralizer according to the present invention is characterized by using the ion generation device described in any of the above.

### Advantageous Effects of Invention

According to the present invention, it becomes possible to provide an ion generation device of which ion balance distribution is uniform and which is capable of making ions reach in a wide range with high ion concentration, and an electrostatic neutralizer.

### BRIEF DESCRIPTION OF DRAWINGS

FIG. 1 is a schematic perspective view showing an ion generation unit 1 according to an embodiment 1;

FIG. 2 is a top view of an internal configuration of an electrostatic neutralizer 100 according to the embodiment 1;

FIG. 3 is a measurement result of ion balance of the electrostatic neutralizer 100;

FIG. 4 is a top view of an internal configuration of an electrostatic neutralizer 101 according to an embodiment 2;

FIG. 5 is a measurement result of ion balance of the electrostatic neutralizer 101;

FIG. 6 is a schematic perspective view of an ion generator 60 according to an embodiment 3;

FIG. 7 is a top view of an internal configuration of an electrostatic neutralizer 102 according to the embodiment 3;

FIG. 8 is a top view of an internal configuration of an electrostatic neutralizer 800 according to a comparative example 1;

FIG. 9 is a measurement result of ion balance of the electrostatic neutralizer 800;

FIG. 10 is a top view of an internal configuration of an electrostatic neutralizer 801 according to a comparative example 2;

FIG. 11 is a measurement result of ion balance of the electrostatic neutralizer 801;

FIG. 12 is a top view of an internal configuration of an electrostatic neutralizer 802 according to a comparative example 3;

FIG. 13 is a measurement result of ion balance of the electrostatic neutralizer 802;

FIG. 14 is a schematic view of an electrostatic neutralization device 900 of a conventional technology;

FIG. 15 is a schematic view of the electrostatic neutralization device 900 of the conventional technology;

FIG. 16 is a schematic view of the electrostatic neutralization device 900 of the conventional technology; and

FIG. 17 is a schematic view of the electrostatic neutralization device 900 of the conventional technology.

### DESCRIPTION OF EMBODIMENTS

Description will hereinafter be given for embodiments of the present invention by using drawings. Note that, the following embodiments are examples in which the present invention is specified and do not limit the technical scope of the present invention.

### Embodiment 1

As one mode for carrying out the present invention, description will be given for an example of an electrostatic neutralizer using an ion generation unit that an electrode generating positive ions and an electrode generating negative ions are configured as one unit.

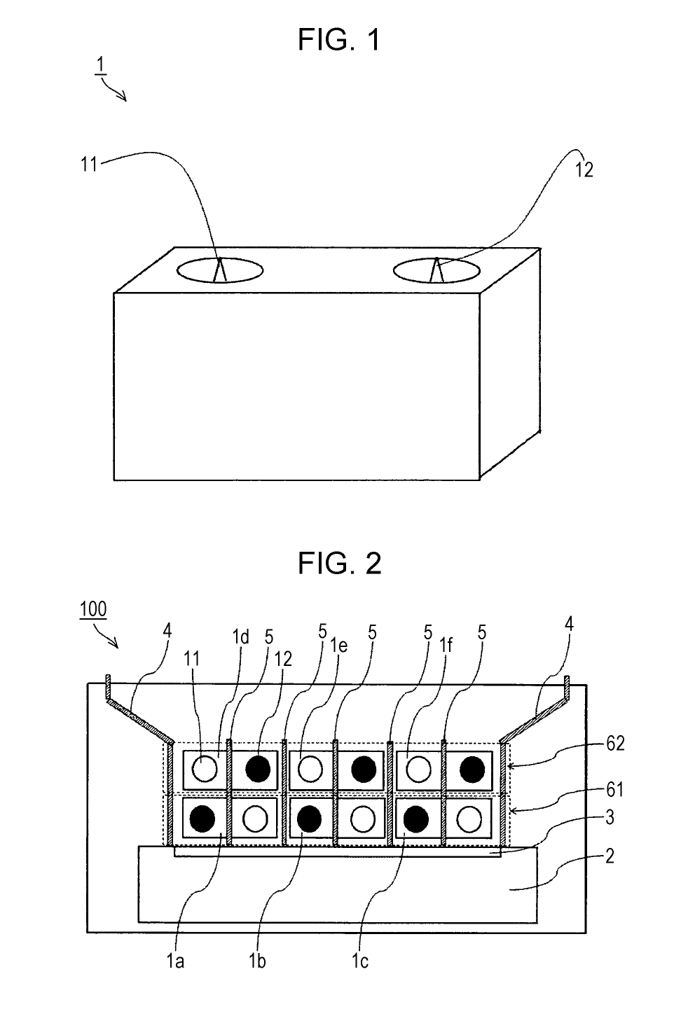

FIG. 1 is a schematic perspective view showing an ion generation unit 1 provided in the electrostatic neutralizer according to the present embodiment. The ion generation unit 1 has a positive ion generation electrode 11 which generates positive ions and a negative ion generation electrode 12 which generates negative ions as one unit, and the electrostatic neutralizer is provided with six units of the ion generation units 1.

FIG. 2 is a top view of an internal configuration of an electrostatic neutralizer 100 according to the present embodiment. The electrostatic neutralizer 100 is provided with ion generation units 1a, 1b, 1c, 1d, 1e and 1f, a cross-roller fan 2, a fan air outlet 3, air duct walls 4 and partition walls 5. Each of the ion generation units 1a, 1b, 1c, 1d, 1e and 1f is provided with the positive ion generation electrode 11 and the negative ion generation electrode 12.

The cross-roller fan 2 has an effective air blowing width of 230 mm, the ion generation units 1a, 1b and 1c are arrayed in a width direction of the cross-roller fan 2 in a vicinity of the fan air outlet 3 and further the ion generation units 1d, 1e and 1f are arrayed in the width direction of the cross-roller fan 2 in an ion blowout direction, so that six units are arranged in total.

Here, three units of the ion generation units 1a, 1b and 1c which are arranged in an upstream side of a blowout direction of conveying air from the cross-roller fan 2 are configured as a first unit group 61 and three units of the ion generation units 1d, 1e and 1f which are arranged in a downstream side are configured as a second unit group 62. Moreover, when viewed from a front of the figure, an up and down direction thereof is defined as a front and back direction of the electrostatic neutralizer 100. That is, as shown in FIG. 2, the first unit group 61 and the second unit group 62 are arrayed in a back row and a front row, respectively, almost in parallel. In addition, the units close to the fan air outlet 3 are the first unit group 61 and the far units are the second unit group 62. Since each unit is arranged in this manner, an arrangement direction of each unit goes along a flow direction of the conveying air.

In each unit group, the ion generation units are arranged in a row so that electrodes having different polarities are adjacent. Furthermore, in the first unit group 61 and the second unit group 62, each unit is arranged so that electrodes opposing in the front and back direction have reverse polarities respectively. The positive ion generation electrodes 11 and the negative ion generation electrodes 12 at this time are arranged vertically upward (near side of the figure), and tip ends thereof face upward. Moreover, each ion generation unit has a voltage application circuit for applying a high voltage (not shown), and in this voltage application circuit, a voltage is able to be applied to each unit group alternately.

The voltage application circuit repeats application and non-application of the voltage simultaneously in a certain cycle with respect to each electrode of the respective unit groups. That is, after a certain ion generating time period, the same time period of non-ion generating time period is waited for to perform generation and non-generation of ions periodically. In the case of the present practical example, a frequency therefor is set to 8 Hz. Moreover, ion generation of the first unit group 61 and the second unit group 62 is shifted by a half cycle, and the respective unit groups do not generate ions simultaneously.

With this configuration, the positive and negative ion generation electrodes are arrayed alternately both in the width direction and the front and back direction to generate positive and negative ions and further to generate positive and negative ions time-periodically, so that the positive and negative ions are generated alternately and equally in terms of space and time, thus making it possible to realize uniform ion balance.

The air duct walls 4 are provided inside the electrostatic neutralizer 100 and control a wind direction of wind generated by the cross-roller fan 2. Moreover, the air duct walls 4 are for controlling a reaching range of ions, that is, a region in which destaticization is possible, and provided along side surfaces of the first unit group 61 and the second unit group 62 which are described above. Furthermore, the air duct walls 4 are respectively provided so that, after passing through the first unit group 61 and the second unit group 62, the conveying air spreads outward at a predetermined angle. With such a configuration, the wind direction of the conveying air flowing along the air duct walls in both end parts of an air duct matches with a direction of arrangement of pairs of front and back electrodes of the end parts. Thereby, balance of positive and negative ions included in the conveying air is able to be maintained, thus making it possible to determine an air blowing range at a predetermined angle thereafter. The angle of the air duct walls 4 may be set as appropriate according to a shape of a destaticization target.

The partition walls 5 are provided so as to separate each electrode pair which is paired in the front and back direction of the first unit group 61 and the second unit group 62. With such a configuration, it is possible to avoid the positive and negative ions generated simultaneously from the adjacent ion generation electrodes to be deactivated inside the electrostatic neutralizer 100. As a result thereof, reduction of ion concentration is avoided, thus making it possible to shorten a destaticization time.

Here, in order to evaluate performance of the electrostatic neutralizer 100, measurement below was performed. As a method for evaluating destaticization performance of the electrostatic neutralizer, a charged plate is generally used. In the present embodiment, a charged plate of 25 mm square having an electrostatic capacity of 5 pF, which is manufactured by TREK, INC., is used, and a destaticization speed is evaluated by a destaticization time (second) which is an average of a positive-side destaticization time (second) till a surface potential thereof reaches +100 V from +1000 V and a negative-side destaticization time (second) till reaching −100 V from −1000 V. A distance between the electrostatic neutralizer and the charged plate is set to 100 mm. In addition, ion balance which is dispersion of the surface potential of the charged plate after destaticization is also set as an evaluation item. An average value of the surface potential of the charged plate for 10 seconds is set as the ion balance, and, generally, it is able to be said that a charged state of a destaticization target after destaticization is excellent if the ion balance is within ±20 V. The ion balance and the destaticization speed were evaluated by setting a center of the width direction of the cross-roller fan 2 as 0 mm to perform measurement in a range of −150 mm to +150 mm at a pitch of 25 mm.

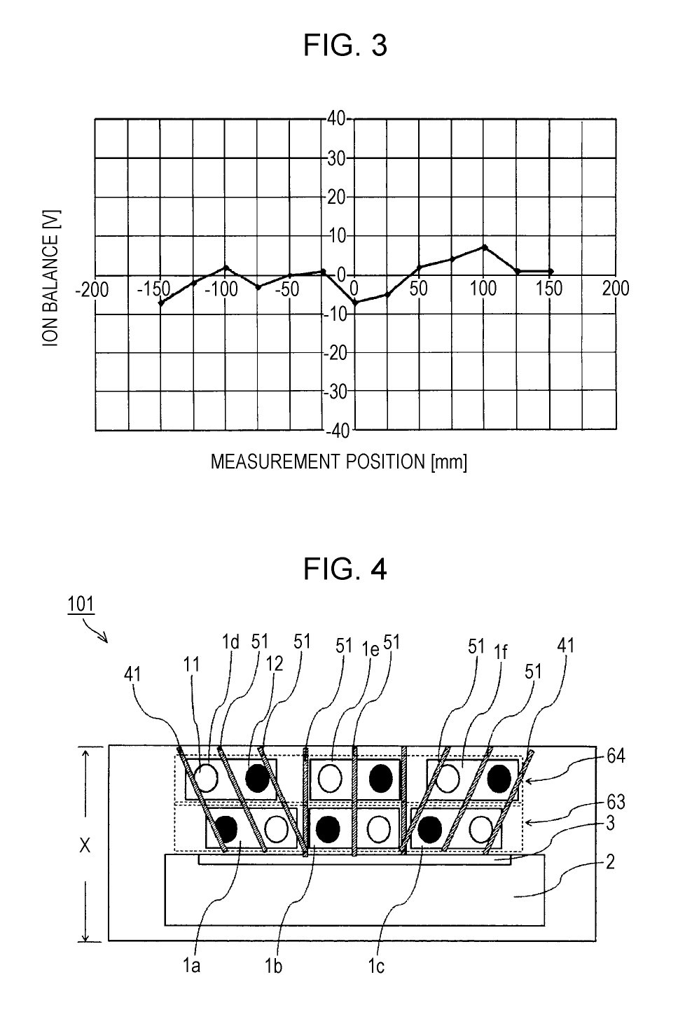

FIG. 3 is a measurement result of ion balance of the electrostatic neutralizer 100, in which a vertical axis indicates an ion balance amount and a horizontal axis indicates a measurement position. Regardless of the measurement position, the ion balance falls within ±20 V, and this result shows that a charged state of a destaticization target after destaticization is excellent.

### Embodiment 2

Next, description will be given for an embodiment 2. In the present embodiment, an example in which arrangement intervals of the ion generation units in each unit group are different will be described. Note that, components described in the embodiment 1 are regarded to have the same functions as those of the embodiment 1 and description thereof will be omitted unless description is particularly given.

FIG. 4 is a top view of an internal configuration of an electrostatic neutralizer 101 according to the present embodiment. The electrostatic neutralizer 101 is provided with the ion generation units 1a, 1b, 1c, 1d, 1e and 1f, the cross-roller fan 2, the fan air outlet 3, air duct walls 41 and partition walls 51. Here, three units of the ion generation units 1a, 1b and 1c which are arranged in the upstream side of the blowout direction of the conveying air from the cross-roller fan 2 are configured as a first unit group 63 and three units of the ion generation units 1d, 1e and 1f which are arranged in the downstream side are configured as a second unit group 64, and when viewed from a front of the figure, an up and down direction thereof is defined as a front and back direction of the electrostatic neutralizer 101.

The air duct walls 41 are provided inside the electrostatic neutralizer 101 and control the wind direction of the wind generated by the cross-roller fan 2. The air duct walls 41 are for controlling a reaching range of ions, that is, a region in which destaticization is possible, and provided along side surfaces of the first unit group 63 and the second unit group 64 which are described above.

As shown in the figure, respective unit groups are arranged in two rows of front and back, and arrangement intervals in the row of each unit constituting the second unit group 64 in the front row is arranged so as to be wider than arrangement intervals in the row of each unit constituting the first unit group 63 in the back row. Then, the partition walls 51 are provided so as to separate each electrode pair which is paired in the front and back direction. The partition walls 51 are able to avoid positive and negative ions generated simultaneously from adjacent ion generation electrodes to be deactivated inside the electrostatic neutralizer 101 as well as to determine the wind direction from the cross-roller fan 2. That is, each air duct partitioned by the partition walls 51 has a structure which has an angle defined by a difference of the arrangement intervals of the ion generation units between the front row and the back row.

In the present embodiment, it is set that the arrangement interval of the first unit group 63 and the second unit group 64 is 15 mm, and arrangement pitches of each unit are 20 mm in the second unit group 64 and 8 mm in the first unit group 63, so that unit arrangement intervals of the second unit group 64 in the front row are set to be wider than unit arrangement intervals of the first unit group 63 in the back row. In such a manner, by making arrangement intervals of the ion generation units different between the front row and the back row, in addition to an effect of the embodiment 1, a depth direction X of the electrostatic neutralizer 101 is shortened, thus making it possible to attain miniaturization and thinning of the device.

Here, in order to evaluate performance of the electrostatic neutralizer 101, ion balance evaluation which is the same as that of the aforementioned embodiment 1 was performed.

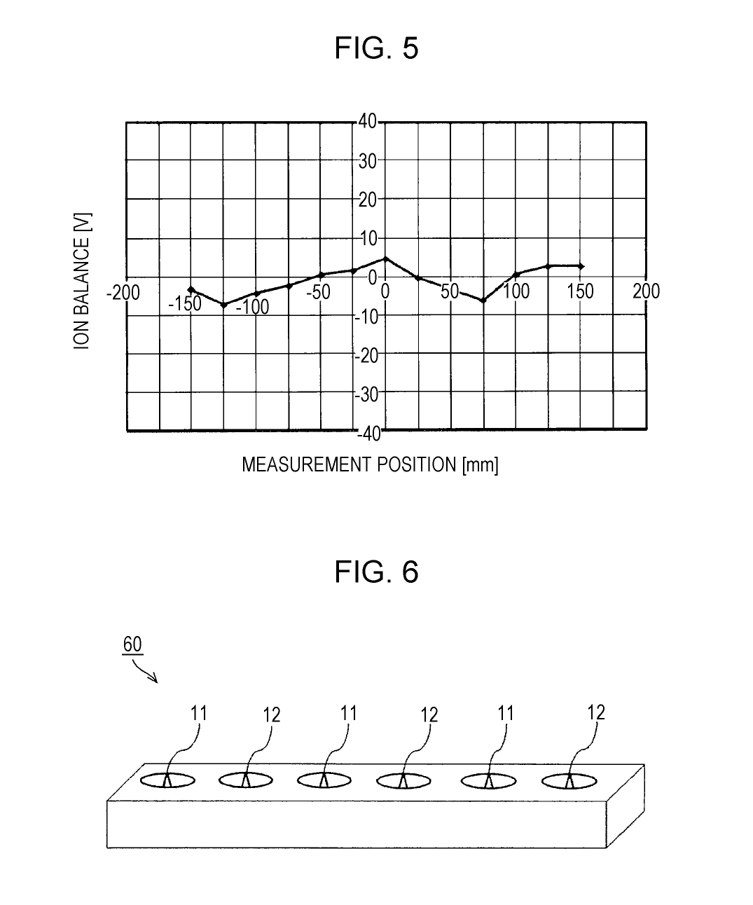

FIG. 5 is a measurement result of ion balance of the electrostatic neutralizer 101, in which a vertical axis indicates an ion balance amount and a horizontal axis indicates a measurement position. Regardless of the measurement position, the ion balance falls within ±20 V, and this result shows that a charged state of a destaticization target after destaticization is excellent.

### Embodiment 3

Next, description will be given for an embodiment 3. The present embodiment is different from any of the aforementioned embodiments in that the ion generation units used above are not arranged in units and a bar-like ion generator in which positive ion generation electrodes and negative ion generation electrodes are arranged alternately is used.

FIG. 6 is a schematic perspective view showing one example of an ion generator 60 used in the present embodiment. In the ion generator 60, the positive ion generation electrodes 11 and the negative ion generation electrodes 12 are arranged alternately on a bar-like substrate. Intervals of the positive ion generation electrodes 11 and the negative ion generation electrodes 12 are set as appropriate according to specifications of an electrostatic neutralizer to be used.

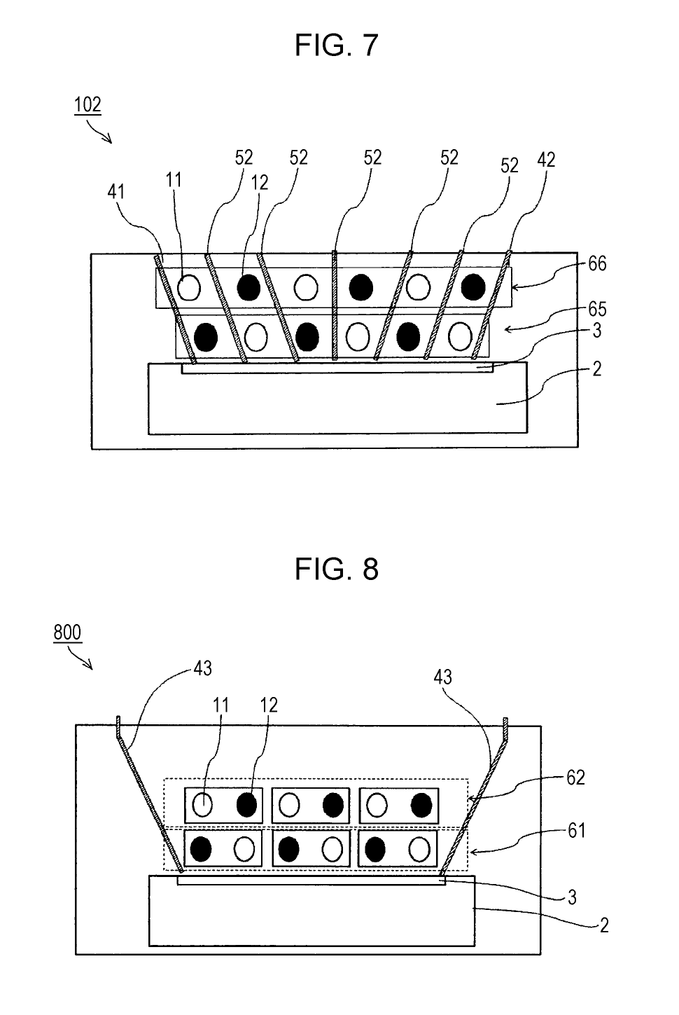

FIG. 7 is a top view of an internal configuration of an electrostatic neutralizer 102 according to the present embodiment. The electrostatic neutralizer 102 is provided with ion generators 65 and 66, the cross-roller fan 2, the fan air outlet 3, air duct walls 42 and partition walls 52. Here, the ion generator 65 is arranged in the upstream side of the blowout direction of the conveying air from the cross-roller fan 2. The ion generator 66 is arranged in the downstream side, and the ion generators 65 and 66 are almost in parallel to each other. When viewed from a front of the figure, an up and down direction thereof is defined as a front and back direction of the electrostatic neutralizer 102.

In each of the ion generators, electrodes having different polarities are arranged in a row so as to be adjacent, and in the ion generators 65 and 66, opposing electrodes are arranged so as to have reverse polarities respectively in a front and back direction. Moreover, arrangement intervals of the positive ion generation electrodes 11 and the negative ion generation electrodes 12 in the ion generator 65 are narrower than arrangement intervals of the positive ion generation electrodes 11 and the negative ion generation electrodes 12 in the ion generator 66. The positive ion generation electrodes 11 and the negative ion generation electrodes 12 at this time are arranged vertically upward (near side of the figure), and tip ends thereof face upward.

The air duct walls 42 are provided inside the electrostatic neutralizer 102 and control the wind direction of the wind generated by the cross-roller fan 2. The air duct walls 42 are for controlling a reaching range of ions, that is, a region in which destaticization is possible, and provided along side surfaces of the ion generators 65 and 66.

By using the ion generators 65 and 66 in which the positive ion generation electrodes 11 and the negative ion generation electrodes 12 are arranged at predetermined intervals in advance in this manner, in addition to effects described in the embodiments 1 and 2, a configuration of the electrostatic neutralizer 102 becomes simple, so that, compared with the cases using the units used in the embodiments 1 and 2, degree of freedom in arrangement of the ion generation electrodes is increased as well as assembling thereof is able to be performed easily.

In order to confirm the effect of each embodiment described above, comparative evaluation was performed in following configurations as comparative examples.

### Comparative Example 1

FIG. 8 is a top view of an internal configuration of an electrostatic neutralizer 800 of a comparative example 1. The electrostatic neutralizer 800 does not include partition walls for separating each electrode pair which is paired in the front and back direction in the first unit group 61 and the second unit group 62, and air duct walls 43 are provided so as to spread toward outside the electrostatic neutralizer 800 from a vicinity of the fan air outlet 3 of the cross-roller fan 2.

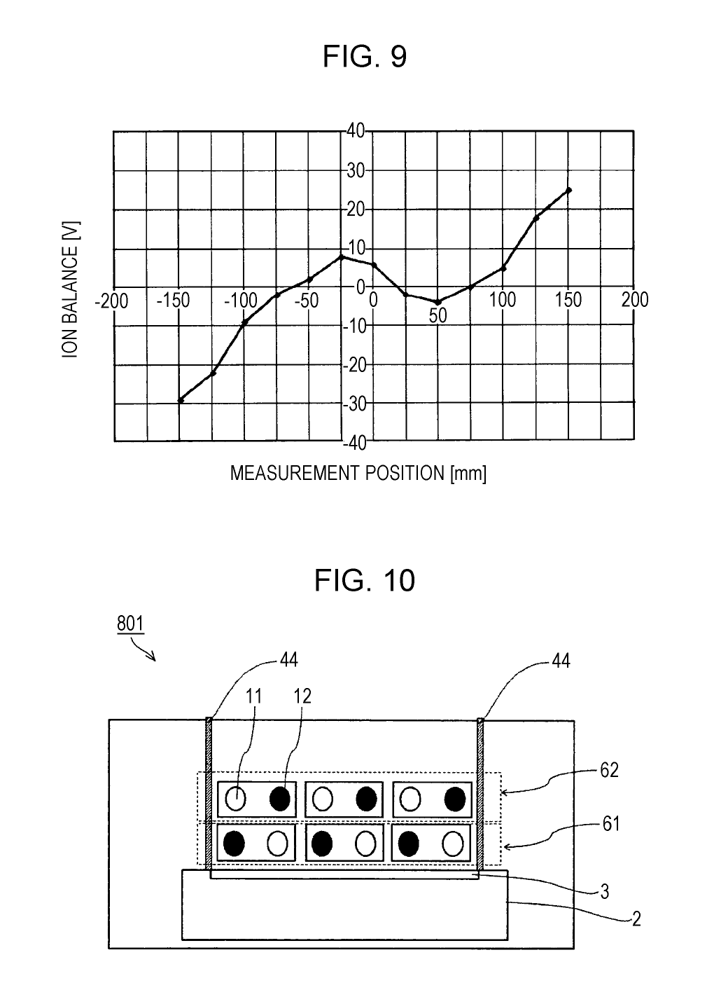

FIG. 9 is a measurement result of ion balance of the electrostatic neutralizer 800, in which a vertical axis indicates an ion balance amount and a horizontal axis indicates a measurement position. This result shows that ion balance at measurement points in both end parts (±150 mm and ±125 mm) are bad compared with a center part. That is, in conveying air flowing along the air duct wall in a left side, many of negative ions generated from a leftmost electrode of the first unit group 61 are included and positive ions generated from a leftmost electrode of the second unit group 62 are difficult to be included. On the other hand, in conveying air flowing along the air duct wall in a right side, many of positive ions generated from a rightmost electrode of the first unit group 61 are included and negative ions generated from a rightmost electrode of the second unit group 62 are difficult to be included. Therefore, it is possible to say that a proportion of the positive and negative ions included in the conveying air in vicinities of the air duct walls 43 in both ends, which are provided in order to widen the conveying air in a width direction, became uneven.

In other words, it is possible to say that, since a wind direction of the conveying air flowing along the air duct walls in both end parts of an air duct does not match with a direction of arrangement of pairs of front and back electrodes of the end parts, the proportion of the positive and negative ions included in the conveying air broke down.

### Comparative Example 2

FIG. 10 is a top view of an internal configuration of an electrostatic neutralizer 801 of a comparative example 2. The electrostatic neutralizer 801 has a same configuration as that of the comparative example 1, except that air duct walls 44 are provided so as not to spread toward outside of the electrostatic neutralizer 801 from the vicinity of the fan air outlet 3 of the cross-roller fan 2 but to be perpendicular along the first unit group 61 and the second unit group 62.

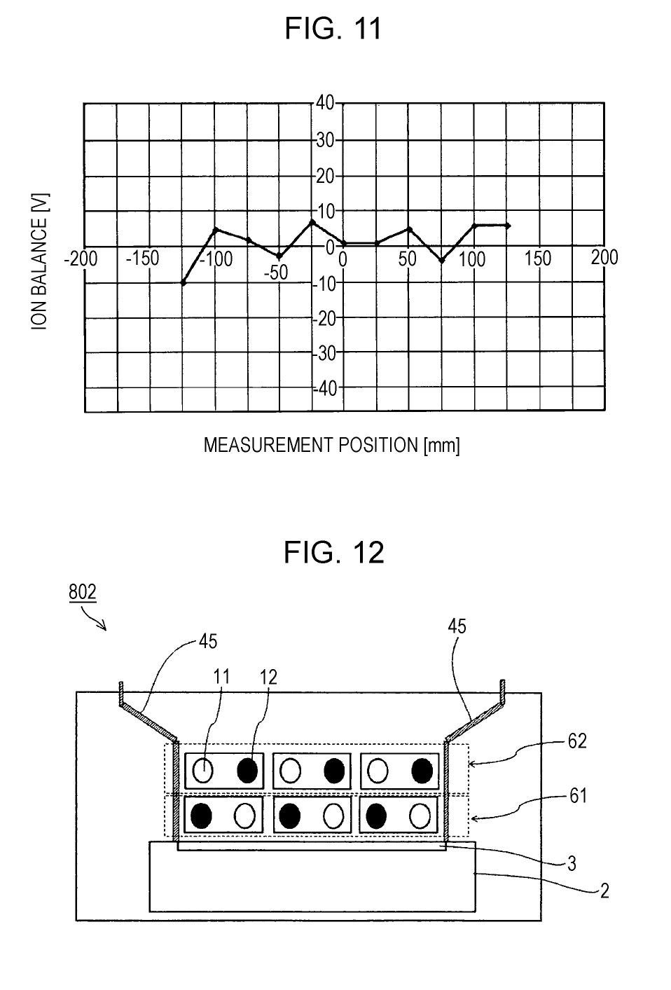

FIG. 11 is a measurement result of ion balance of the electrostatic neutralizer 801, in which a vertical axis indicates an ion balance amount and a horizontal axis indicates a measurement position. It can be confirmed that ion balance within a range from −125 mm to +125 mm has been improved from the comparative example 1. However, at measurement points of −150 mm and +150 mm, destaticization was not possible (destaticization is not finished within a predetermined time). That is, by making a wind direction of conveying air flowing in both end parts of an air duct parallel to a direction of arrangement of pairs of front and back electrodes to thereby balance positive and negative ions included in the conveying air, it is possible to avoid breaking down of the ion balance, but diffusion in the width direction of the conveying air results in being suppressed, so that a width of a region in which destaticization is possible is to be narrowed from an original one.

### Comparative Example 3

FIG. 12 is a top view of an internal configuration of an electrostatic neutralizer 802 of a comparative example 3. In the electrostatic neutralizer 802, air duct walls 45 are provided so as not to spread toward outside of the electrostatic neutralizer 801 from the vicinity of the fan air outlet 3 of the cross-roller fan 2 but to be perpendicular along the first unit group 61 and the second unit group 62, and provided so that conveying air spreads outside respectively at a predetermined angle after passing through the first unit group 61 and the second unit group 62.

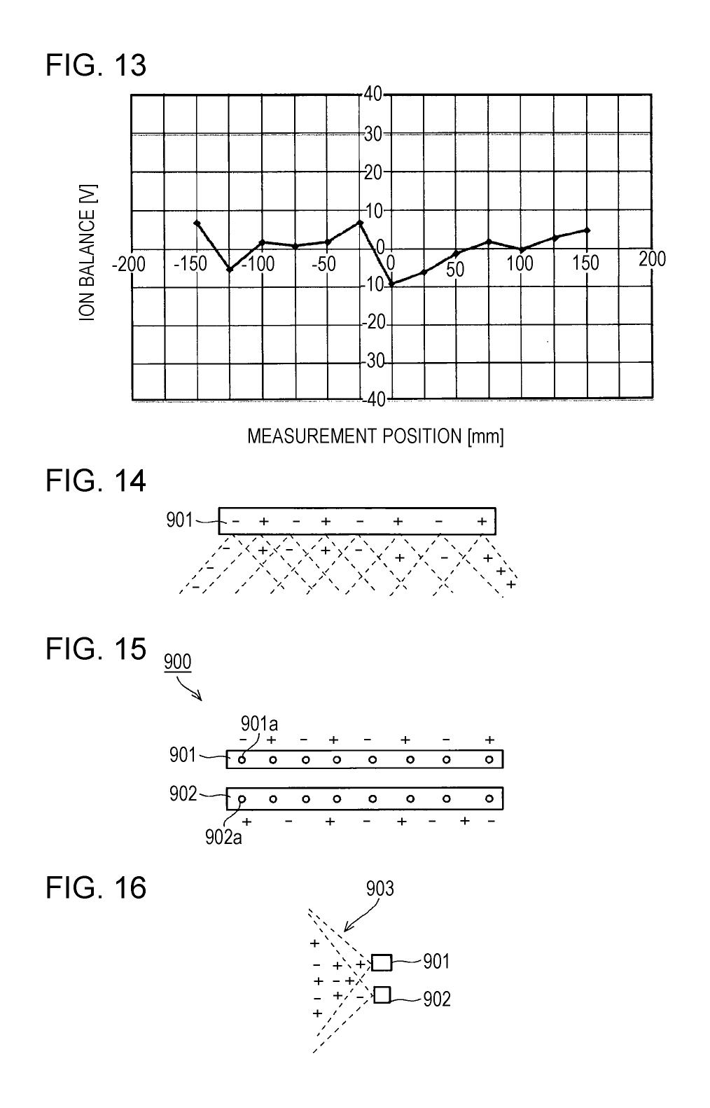

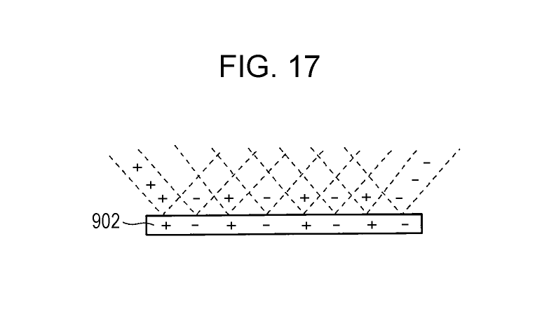

FIG. 13 is a measurement result of ion balance of the electrostatic neutralizer 802, in which a vertical axis indicates an ion balance amount and a horizontal axis indicates a measurement position. It is shown that destaticization is possible in the entire region from −150 mm to +150 mm, and the ion balance is excellent in the entire area. However, compared with the aforementioned embodiment 1 which is provided with the partition walls 5, dispersion of ion balance was found. In addition, compared with the aforementioned embodiment 1, an average destaticization time became longer by 0.5 second. It is considered that this is because, by including no partition wall, positive ions and negative ions generated from adjacent ion generation electrodes are neutralized, and an ion generation amount is reduced.

As described above, it becomes possible to realize an ion generation device, including: first ion generation means and second ion generation means in which positive ion generation electrodes and negative ion generation electrodes are arranged alternately in a row; a high-voltage power source that applies a high voltage to the first ion generation means and the second ion generation means; air blowing means for sending ions generated by the first ion generation means and the second ion generation means to an outside of electric equipment with conveying air; and an air duct wall that partitions the conveying air in an air flow direction, in which the first ion generation means and the second ion generation means are arranged in substantially parallel to each other and arranged along the flow direction of the conveying air in this order from an upstream side of the conveying air, polarities of ions radiated from the ion generation electrodes, which are respectively opposing, of the first ion generation means and the second ion generation means are reverse polarities, the air duct wall is arranged so as to separate each pair of positive and negative electrodes to be paired over the first ion generation means and the second ion generation means, and the high-voltage power source applies the voltage to the first ion generation means and the second ion generation means alternately, and therefore ion balance distribution is uniform and ions are able to be reached in a wide range with high ion concentration, and an electrostatic neutralizer.

### INDUSTRIAL APPLICABILITY

An ion generation device according to the present invention is preferably usable for electrical equipment which emits ions in a room, such as an air cleaner, an air conditioner, a humidifier, a dehumidifier and an electrostatic neutralizer.

### REFERENCE SIGNS LIST

1, 1a, 1b, 1c, 1d, 1e, 1f ion generation unit

2 cross-roller fan

3 fan air outlet

4, 41, 42 air duct wall

5, 51, 52 partition wall

11 positive ion generation electrode

12 negative ion generation electrode

60, 65, 66 ion generator

61, 63 first unit group

62, 64 second unit group

100, 101 electrostatic neutralizer

1. An ion generation device, comprising:
first ion generation means and second ion generation means in which positive ion generation electrodes and negative ion generation electrodes are arranged alternately in a row;
a high-voltage power source that applies a high voltage to the first ion generation means and the second ion generation means;
air blowing means for sending ions generated by the first ion generation means and the second ion generation means to an outside of electric equipment with conveying air; and
an air duct wall that partitions the conveying air in an air flow direction, wherein
the first ion generation means and the second ion generation means are arranged in substantially parallel to each other and arranged along the flow direction of the conveying air in this order from an upstream side of the conveying air,
polarities of ions radiated from the ion generation electrodes, which are respectively opposing, of the first ion generation means and the second ion generation means are reverse polarities,
the air duct wall is arranged so as to separate each pair of positive and negative electrodes to be paired over the first ion generation means and the second ion generation means, and
the high-voltage power source applies the voltage to the first ion generation means and the second ion generation means alternately.

2. The ion generation device according to claim 1, wherein an arrangement direction of the first ion generation means and the second ion generation means and the flow direction of the conveying air are substantially parallel, and the flow direction of the conveying air changes after passing through the first ion generation means and the second ion generation means.

3. The ion generation device according to claim 1, wherein an arrangement interval of the ion generation electrodes of the first ion generation means is different from an arrangement interval of the ion generation electrodes of the second ion generation means.

4. The ion generation device according to claim 3, wherein the arrangement interval of the ion generation electrodes of the first ion generation means is narrower than the arrangement interval of the ion generation electrodes of the second ion generation means.

5. An electrostatic neutralizer that uses the ion generation device according to claim 1.
